(19) United States
(12) Patent Application Publication
(10) Pub. No.: US 2024/0316882 A1
(43) Pub. Date: Sep. 26, 2024

(54) LASER HEATING SYSTEM FOR SMALL-TOW TOW LANES ON AFP HEADS

(71) Applicant: Electroimpact, Inc., Mukilteo, WA (US)

(72) Inventors: Jacob H. ROWER, Seattle, WA (US); Marcus Jordan BOYLE, Seattle, WA (US)

(21) Appl. No.: 18/677,429

(22) Filed: May 29, 2024

Related U.S. Application Data
(63) Continuation-in-part of application No. 16/783,895, filed on Feb. 6, 2020, now Pat. No. 12,023,877.
Application No. 16/783,895 is a continuation-in-part of application No. 16/736,679, filed on Jan. 7, 2020, now abandoned.

(51) Int. Cl. B29C 70/38; B29C 35/08

(52) U.S. Cl. CPC B29C 70/384; B29C 35/0805; B29C 2035/0822; B29C 2035/0838

(57) ABSTRACT

An Automatic Fiber Placement (AFP) machine includes an optical assembly for selectively heating individual small-width tows as they are fed for placement on a substrate. The optical assembly includes a plurality of collimators arranged in parallel in at least two rows and having a pitch less than 0.5 inches to accommodate placement of small-width tows.

This application is a continuation-in-part of co-pending U.S. patent application Ser. No. 16/783,895, filed on Feb. 6, 2020, which is a continuation-in-part of U.S. patent application Ser. No. 16/736,679 filed on Jan. 7, 2020, now abandoned, all of which are incorporated by reference herein.

### BACKGROUND

An AFP machine includes an AFP head which includes a plurality of spool assemblies which use composite tow that is wound onto a bobbin. Each spool feeds a single tow for lamination on a substrate. In operation, multiples spools of material are unwound and the material is placed onto the part in a “course.” Multiple courses of composite material in a single layer comprise a “ply,” as shown in FIG. 1. A part, such as used in the commercial aircraft industry, is built up using multiple plies with various orientations, as shown in FIG. 2. Each ply is considered in sequence to be a substrate as new courses are deposited on them. Heat is applied during the process so that the material deposited by the AFP head, sometimes referred to as an end effector, adheres to the substrate. Typical ply orientations are 0, 45, 90 and 135 degrees. A ply may be applied at any angle, even parallel to the previous ply, but more likely parallel to a ply several courses previous. The tow may also be steered or directed under control in a selected path, e.g. curved or more complex, onto the part or also designed to cover only a small portion of the substrate. A compaction roller is used to compress the course onto the substrate.

Different composite materials are used in AFP machines. One common material for aircraft parts, for instance, is carbon fiber that is pre-impregnated with a thermoset resin. The material is stored in a freezer to prevent the resin from prematurely curing.

Another material is a “dry” carbon fiber which is later infused with resin in a secondary process and then cured. In order to enable the dry fiber material to be deposited and consolidated with an AFP machine, a thin veil of resin, usually a thermoplastic resin, coats the fibers. More heat is required to make a laminate with dry fiber in comparison with thermoset.

Still another material is thermoplastic pre-impregnated fiber. Thermoplastic resin material typically requires more heat to process properly than either dry fiber or thermoset fiber. Since more heat is required to make a laminate with thermoplastic, only the higher power heating solutions will be effective. Other fibers used include boron fiber, glass fiber, Kevlar fiber and lightning strike material.

As indicated above, heating is necessary for composite fiber material used in AFP machines to adhere to and consolidate with the substrate. One known technique uses infrared bulb heaters. The infrared light heats the substrate ahead of the nip point. The infrared output is not focused, resulting in heating of an area wider than the course being processed. Multiple bulbs are needed to produce the desired heating of a course. When the AFP machine stops, the retained heat in the bulbs can damage the substrate. Consequently, an air knife is engaged to redirect the stored heat from the bulbs away from the part. Pre-heating the bulbs when approaching the start of a course, and monitoring the latent energy and other measures are necessary to achieve reliable results.

Another known heating technique uses a pulsed flash lamp. Like the infrared light bulbs, the pulsed flash lamp also is sized for the entire width of the course and does not allow for energy to be dynamically switched on and off to each tow lane.

Still another heating technique utilizes a single laser for the entire course width. The single laser can include a fiber-coupled laser in order to move the mass of the laser source off of the AFP head, with optics to focus the energy necessary for consolidation, but again this technique is for the entire width of a course. Over 1 KW of infrared energy is required in conventional implementations, and they include a large power supply at the base of the machine that transmits infrared light energy via a flexible fiber optic cable. A fiber optic termination and lens system is mounted on the AFP head. The output beam is pointed at and in line-of-sight with the nip point across the width of a subject course. The beam is adjusted to be the exact width of the course (or partial course). With a single laser for the entire course, there is no capability of switching the heat supply on and off tow by tow. Only the entire course can be switched on and off. Further, a single fiber coupled laser having its laser source located off of the AFP head, is not compatible with a modular AFP head because there is no automatic means to connect and disconnect the fiber optic cable. Consequently, the operator of the machine is required to remove the laser-related elements (e.g., optics) manually before the AFP head can be changed out automatically.

A condition known as roller wrap is often a significant limitation on the operation of AFP machines. A roller wrap occurs when substrate material, a tow or a portion of a tow, is inadvertently picked up by the compaction roller and pulled off of the part, wrapping around the compaction roller. Roller wrap has a negative effect on the reliability of AFP machine operation. The end effector (e.g., an AFP head) and the subject part receiving the tows may each require attention in order to recover from a roller wrap condition.

### SUMMARY OF THE INVENTION

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

According to an embodiment, an Automated Fiber Placement (AFP) machine includes an AFP head, a compaction roller, a plurality of laser heat sources, a plurality of fiber optic cables, a plurality of collimators, and a control unit. The AFP head is configured to supply one or more tows under tension. The compaction roller is configured to receive the tows from the AFP head and to press the tows with pressure onto a substrate. The plurality of laser heat sources, implemented as laser heat source modules, each having an electrical power supply. Each laser heat source module is associated with a respective single tow, and is configured to generate infrared energy to heat the associated tow and/or a portion of the substrate associated with the associated tow. The fiber optic cables are each associated with a respective laser heat source module of the plurality of laser heat source modules and are arranged to convey the infrared energy from the respective laser heat source module. The collimators are each connected to a respective fiber optic cable of the plurality of fiber optic cables and are configured to receive, collimate, and direct the infrared energy onto the associated tows at or in front of the nip point thereof. The control unit is configured to control each of the laser heat source modules on and off individually consistent with the supply of its respective associated tow. The control unit controls each laser heat source module so as to be powered on only when its associated tow is known to be fed from the AFP head and powered off only when its associated tow is known not to be fed from the AFP head. According to another embodiment, an optical assembly for an Automated Fiber Placement (AFP) machine includes a plurality of fiber optic terminations configured to receive infrared energy, and to collimate the infrared energy; and a plurality of mirrors configured to receive the collimated infrared energy from the fiber optic terminations and redirect the collimated infrared energy towards a substrate.

According to an embodiment, a method of using an optical assembly in an Automated Fiber Placement (AFP) machine includes supplying the optical assembly. The optical assembly includes, within a chassis, a plurality of fiber optic cables, a respective plurality of collimating devices arranged in at least two staggered rows, and a plurality of mirrors respectively arranged to direct infrared energy received from the collimating devices. The method further includes fixing the optical assembly to the AFP machine and orienting the optical assembly to emit the infrared energy toward nip points of a plurality of fiber tow placement locations. The method also includes attaching each of the fiber optic cables to a respective collimating device held within the chassis. Further, infrared energy is provided to at least one of the fiber optic cables. At least once, a position of at least a subset of the mirrors is adjusted to direct infrared energy received from corresponding collimating devices within a predetermined threshold location range at the respective nip points. The method also includes independently controlling, with an automated controller, a supply of the infrared energy provided to at least one of the plurality of collimating devices based on whether or not the AFP machine is feeding a corresponding fiber tow to the corresponding nip point.

Further scope of applicability of the present invention will become apparent from the Detailed Description given below. However, it should be understood that the Detailed Description and specific examples, while indicating preferred embodiments of the present invention, are given by way of illustration only, since various changes and modifications within the spirit and scope of the present invention will become apparent to those skilled in the art from this Detailed Description.

### BRIEF DESCRIPTION OF THE DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 illustrates an example of a course for fiber placement 8 inches wide, according to conventional art, according to an embodiment.

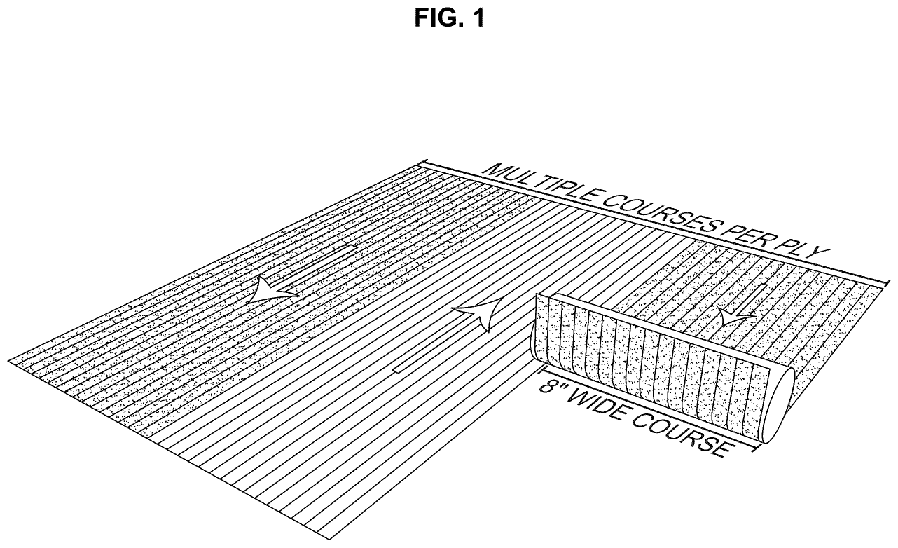

FIG. 2 is a diagram showing a plurality of orientations of fiber courses, according to conventional art, according to an embodiment.

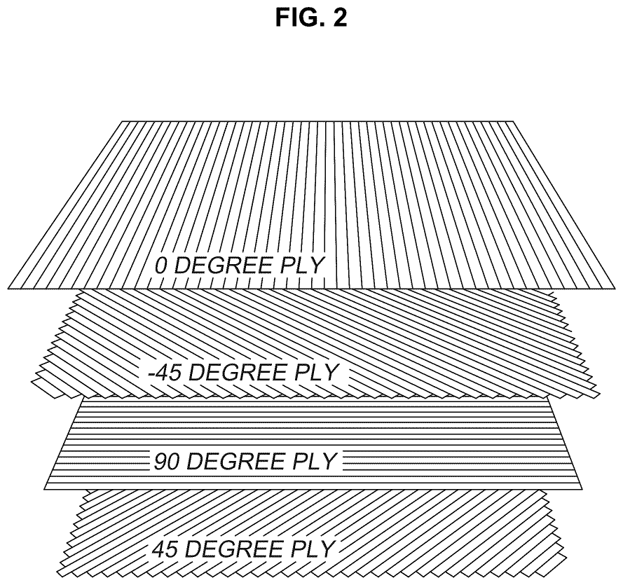

FIG. 3 is a diagram showing a roller wrap risk zone (edge) for a fiber course in a conventional system, according to an embodiment.

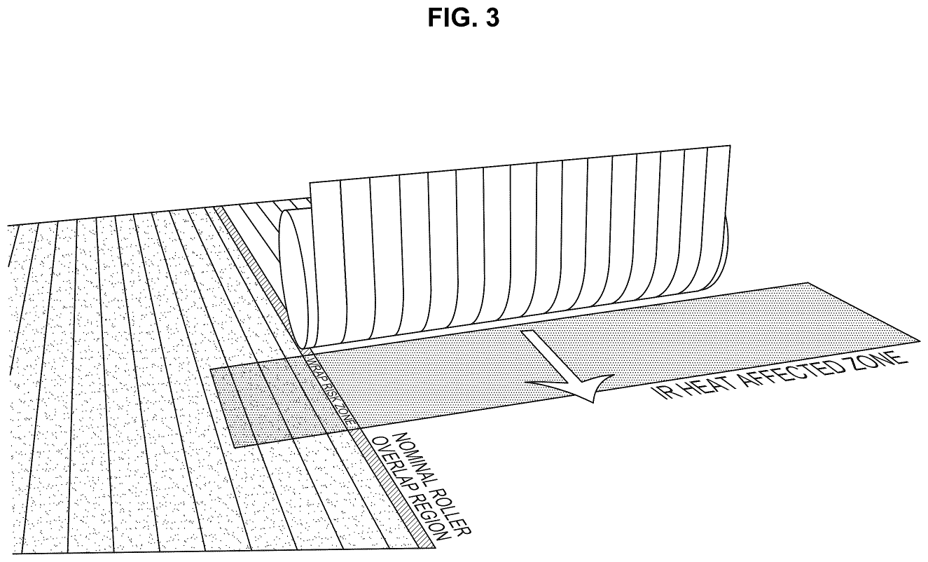

FIG. 4 is a diagram showing a roller wrap risk zone when a single tow is being replaced, according to an embodiment.

FIG. 5 is a schematic view showing an AFP machine configured for laying down a full course of fiber tows, according to an embodiment.

FIG. 6 is a schematic view showing an AFP machine laying down a fiber partial course, according to an embodiment.

FIG. 7A is a combination cutaway view and block diagram illustrating a tow guidance system portion of an AFP head, according to an embodiment.

FIG. 7B is a side view of a placement portion of the AFP head, according to embodiments

FIGS. 8A-8E show various perspectives of an optical assembly, according to an embodiment.

FIG. 9 is a section view of an optical assembly according to an embodiment, and corresponds to the A-A section of FIG. 8E.

FIGS. 10A and 10B are respectively a side view and a perspective view of collimators and corresponding mirrors, according to an embodiment.

FIG. 11 illustrates a distance added by placement of a subset of first mirrors in different rows, according to an embodiment.

FIG. 12 includes end and section view (B-B) of a collimator tube, according to an embodiment.

FIG. 13 is a rear view of a tow guidance system of an Automated Fiber Placement (AFP) machine, according to an embodiment.

FIG. 14 illustrates operations in a method for using an optical assembly, according to an embodiment.

FIG. 15 illustrates a problem with using a single laser source for the entire course width. The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the present invention will now be described. The following description provides specific details for a thorough understanding and enabling description of these examples. One skilled in the relevant art will understand, however, that the present invention may be practiced without many of these details. Likewise, one skilled in the relevant art will also understand that the present invention can include many other obvious features not described in detail herein. Additionally, some well-known structures or functions may not be shown or described in detail below, so as to avoid unnecessarily obscuring the relevant description.

Descriptions of well-known starting materials, processing techniques, components and equipment may be omitted so as not to unnecessarily obscure the present invention in detail. It should be understood, however, that the detailed description and the specific examples, while indicating (e.g., preferred) embodiments of the present invention, are given by way of illustration only and not by way of limitation. Various substitutions, modifications, additions and/or rearrangements within the spirit and/or scope of the underlying inventive concept will become apparent to those skilled in the art from this disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

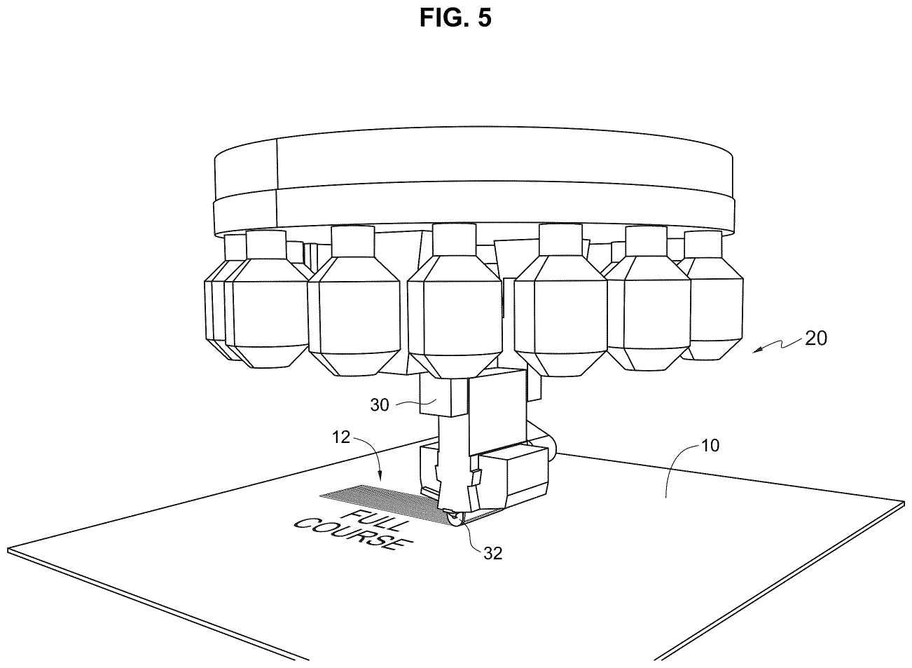

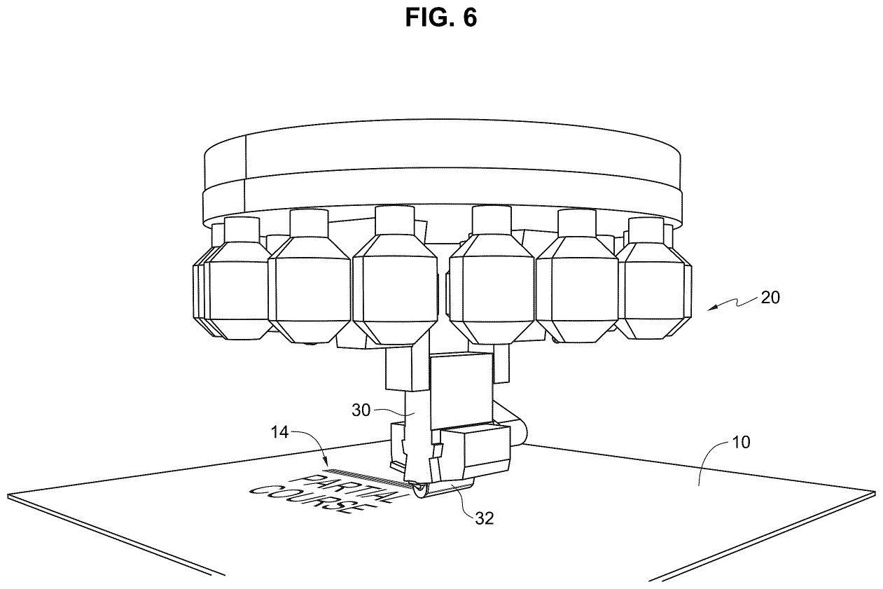

Referring to FIG. 5, an AFP head assembly 20 is shown producing a full course of tows 22 (e.g., sixteen tows). As will be acknowledged by one having skill in the art, an AFP head assembly may produce a partial course of tows. For example, FIG. 6 illustrates the AFP head assembly 20 applying a partial course of tows 23. Tension on the course is produced by normal operation of the AFP head assembly 20 as described, e.g., in U.S. Pat. No. 10,981,342 filed Nov. 18, 2018, owned by the assignee of the present disclosure, and the contents of which are hereby incorporated by reference.

The present disclosure describes a heating device and method for consolidation of composite material in which multiple laser heat source modules are mounted to the AFP head assembly 20 ahead of a nip point, i.e. the convergence of the tow (fiber material) and the substrate by aid of a compaction roller, with the laser output pointing toward and in line of sight with the nip point. One laser heat source module is mounted on centerline with each tow. Laser heat source modules are each separately wired and plumbed. When energized the laser heat source modules emit infrared laser energy. An AFP machine may provide 1 to 32 lanes of tows. If a multi-lane infrared laser heating system were designed for each of these variations, up to thirty-two different designs would be required. A better solution, disclosed herein, is to provide one type of laser module mounted, oriented and sized to service one lane and then add similar modules as required based on the number of lanes. In this manner, one design of laser heat source module can be independently applied to each tow lane to accommodate all thirty-two machine configurations.

For 0.5 inch tow, over 100 W of continuous rated infrared radiant heat is required for each lane. Water cooling of the laser heat source module may also be required. The heating device thus becomes an enclosed module with both electrical and water connections. There are size restrictions on the heating module to meet the mounting requirements of the present embodiment. The heating module may be at most 0.5 inch in width in order to mount on centerline with the respective tows according to an embodiment. As described below, an offset collimator block may be used in some embodiments to reduce the heating module pitch further. The heating module is disposed in a location that prevents dragging on the substrate while avoiding interference with the AFP head.

The laser heat source modules must each be separately wired to respective laser controller modules which are controlled by a computer.

In a common embodiment of the disclosed device, the tows are each 0.5 inch wide, separated by a very small distance, for instance 0.010 inch. In the present example, sixteen tows are provided, forming a course. It should be understood, however, that different size tows can be used, including, for instance, common widths of 0.25 inches, 0.5 inches, 1.5 inches. It will be acknowledged by those having skill in the art, however, that the smaller sizes (e.g., 0.25 inch) present a challenge with respect to placement of laser collimators. The inventors have addressed this challenge by embodiments disclosed herein. AFP heads can be designed, or in some cases dynamically reconfigured, to supply and simultaneously (or in some cases variably) place one, two, four, eight, sixteen, twenty or thirty-two tows. The most common AFP head size is configured to place sixteen tows with each individual tow being 0.5 inch, so that a head will lay down a course eight inches wide. The tows from an AFP head are maintained in alignment by a tow guidance mechanism 30 as the tows are directed to a compaction roller 32. The compaction roller 32 is generally cylindrical, and is controlled to apply pressure against the tows as they are moved into position for application to a substrate 10. The compaction roller 32 is typically pneumatically pressed down to the surface of the substrate 10. The compaction roller 32 may be any of a variety of sizes, depending on the particular application, and is usually made of a flexible or compliant material. Sufficient force is applied by the compaction roller 32 to press the tow onto the substrate 10, adhering the tows thereto.

In one variation, the laser heat source modules can be pointed at the substrate slightly ahead of the nip point and the same benefits of this disclosure result.

In another variation, the lasers can be mounted slightly off the centerline of the tow while the laser heat window is pointed at the tow center to achieve the same benefits.

A disadvantage of infrared heating spreading out across multiple lanes is the tendency to cause roller wrap. The compaction roller must always be wider than the tows being fed. When a previously laid down tow or a portion of a tow is heated it can become sticky, so that it can stick to the compaction roller and roll up on the compaction roller. This causes the AFP machine to stop until the condition is repaired.

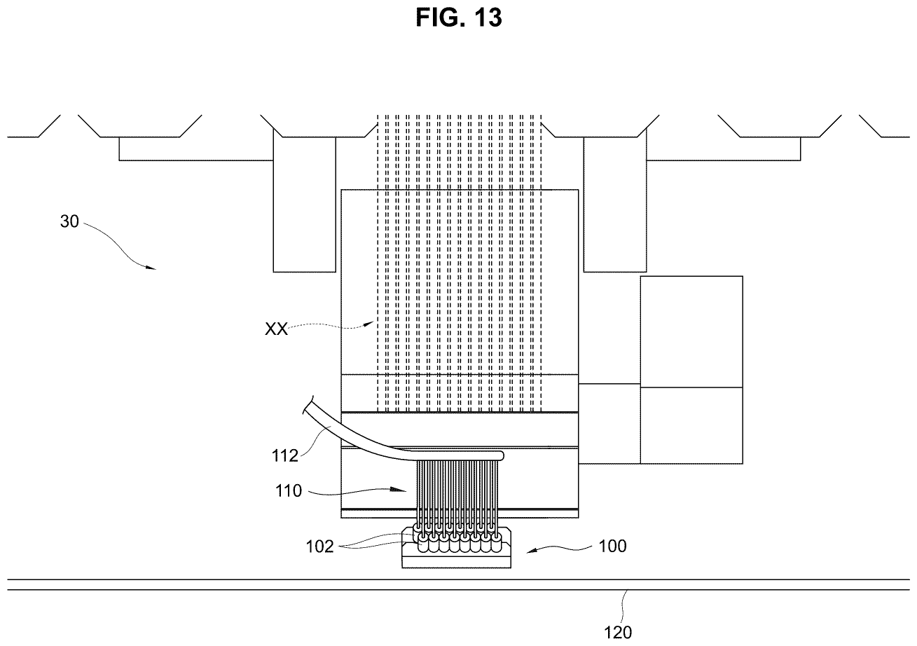

In some implementations, certain laser heat source modules cannot be mounted on centers closer than one half inch. For one half inch tow, e.g., as shown in FIG. 13B, one tow is positioned in front of one heat source module. For smaller tow pitches, e.g., 0.25-inch tow, prior to the present disclosure it was necessary to put two or more tows in front of each laser heat source module. However, to reduce risk of roller wrap the operator would need to always feed all tows for lanes with laser heat source modules on and feeds no tows for lanes with laser heat source modules off. That is, prior to the present disclosure, for tows smaller than 0.5 inch, at least two adjacent tows were required to be fed to reduce risk of roller wrap.

For example, for 0.25-inch tow, if it was necessary to “repair” one tow then it would be beneficial to pull up both the damaged tow and an adjacent tow and then re-lay both tows to get protection against roller wrap. The present disclosure offers a solution that permits a single tow and/or multiple non-adjacent tows to be repaired or initially applied for tows smaller than 0.5 inch.

The laser drivers are individually controlled on/off by logic level (TTL) signals from a Programmable Logic Controller. Each laser driver also has an analog input control to adjust the current flow into each module and proportionally controls the infrared light output. The infrared light output is controlled by an analog output from the programmable logic controller.

Reducing the number of connections through the ATI Industrial Automation interface reduces cost and improves reliability. After passing through the interface the electrical and chilled water connection can branch out and service multiple laser heat source modules or similar modules provide an attractive configuration for a modular head.

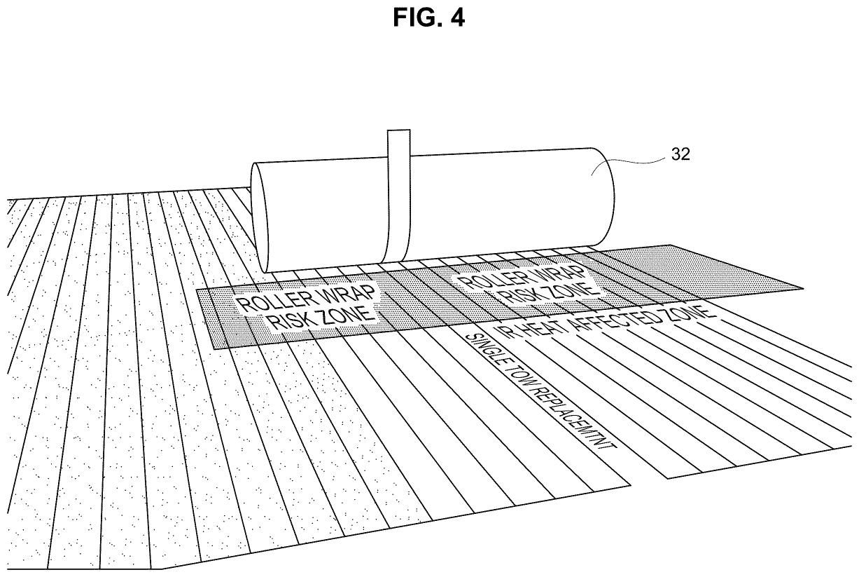

A repair is illustrated in FIG. 4, in particular a single tow replacement for a course of sixteen tows. In FIG. 4 the other fifteen tows are heated by the prior art heating system and come in contact with the compaction roller so they represent a risk for roller wrap. The same thing is true if two tows are replaced. Then there are fourteen tows at risk.

For any partial course with the prior art heating system there is risk in all the open lanes that a previously laid down tow gets heated, sticks to and rolls up on the compaction roller. It can be the entire tow that rolls up or just a portion of the tow.

This invention solved this problem because the laser heat source is only heating the associated tow and not the adjacent tows. If two tows are being replaced then only those two laser heat sources are energized and then only while the two tows are feeding. Therefore, the risk of roller wrap is eliminated.

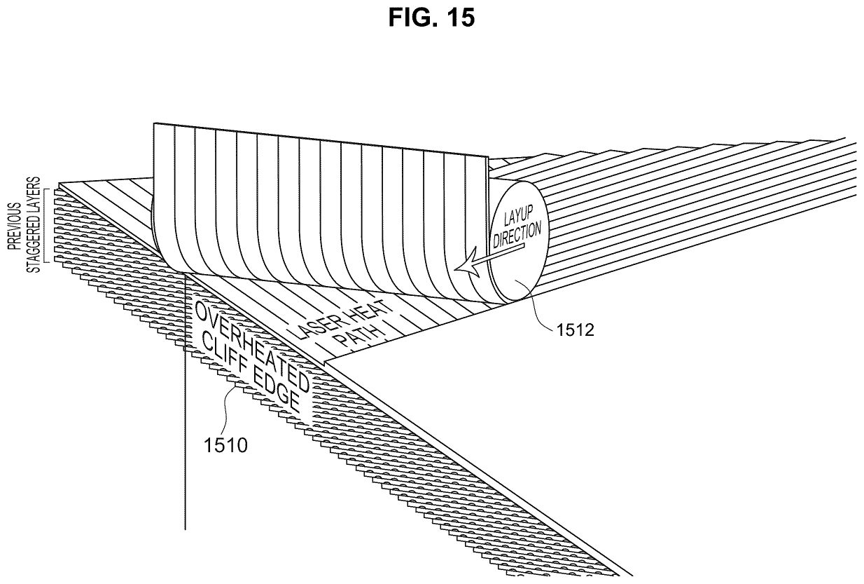

For narrow tow where a pair of tows (0.25 inch) are heated by one laser heat source module or a tetrad (four) of tows (0.125 inch) heated by one laser heat source module it is best to pull up and repair all tows heated by a given laser. It is easy to pull up and re laydown two or four tows as required and get the benefit that this invention offers to eliminate the risk of roller wrap. This illustrates the potential benefit of the presently disclosed system that can address single tows of small width. Also, for partial courses, production planning can either lay all tows for a given laser heat source module or lay no tows for a given laser heat source module to get all the reliability benefits that this invention offers. FIG. 15 illustrates a problem with using a single laser source for the entire course width occurs for thick layups in which the backward pointing laser can “see” the cliff edge 1510 of the part after the compaction roller 1512 has passed over the edge in a stagger pass. This problem is exacerbated for thermoplastic resin, due to the high heat required for consolidation. On the stagger pass the backward-looking laser can see the face of the cliff edge 1510 for an extended period. This extended period of laser heat can cause heat damage or even start the material smoking or catch fire. The present invention resolves this problem. Instead of a full course width laser being left on by necessity the laser heat source module for each lane in the present invention can be switched off the moment its associated tow is dropped. The amount of heat put into the face of the cliff edge is reduced by approximately half.

Thus, with the present invention, it has been demonstrated that laser energy can be controlled so that the laser energy from a laser heat source module is focused on a corresponding tow and that a laser system can be implemented which permits a per-two laser on small-width tows.

One laser heat source module for each tow provides efficiency in design and implementation based on the number of tows. Each laser heat source module is wired and plumbed separately and can be separately controlled by analog or on/off control. If the number of tows is increased on an AFP machine in the middle of a project from sixteen to twenty then all sixteen modules previously provided can still be used and four more modules are added. The mounting bracket is simply lengthened by four positions. With this invention only one part needs to be stocked for AFP heads which feed anywhere from one to thirty-two tows.

There are many benefits to shutting off the lasers for any lane in which the tow is not fed. The laser is projecting radiant heat at or slightly ahead of the nip point, roughly half the radiant heat above on the compaction roller and half below on the substrate. With the previous technology—full course width fiber coupled laser—the entire width of the course is heated or none is heated, For any lanes for which tow is not fed the radiant energy from the infrared laser would shine on the bare compaction roller which reduces the life of the compaction roller. The solution is to use heat source modular lasers which can be shut off lane by lane, as in the present invention. When the tow in a given lane is no longer fed, the heat source modular laser which heats that lane is switched off so the bare compaction roller is not subject to direct heat from the laser.

For narrow tow where there is a pair of tows (0.25 inch) or a tetrad of tows (0.125 inch) heated by one laser heat source module the same benefit will result for not shining laser heat on the compaction roller if all tows for a given laser heat source module are fed and the laser is on, or not fed and the laser is off.

For narrow tow where there is a pair of tows (0.25 inch) or a tetrad of tows (0.125 inch) heated by one laser heat source module the same benefit results for the problem of heating of the cliff edge shown in FIG. 15. For a stagger pass where one laser is heating two tows for consolidation the associated laser heat source module will be switched off when the second tow is dropped, yielding almost the entire benefit for solving the cliff edge heating problem.

Although a preferred embodiment of the invention has been disclosed for purposes of illustration, it should be understood that various changes, modifications and substitutions may be incorporated in the embodiment without departing from the spirit of the invention, which is defined by the claims which follow.

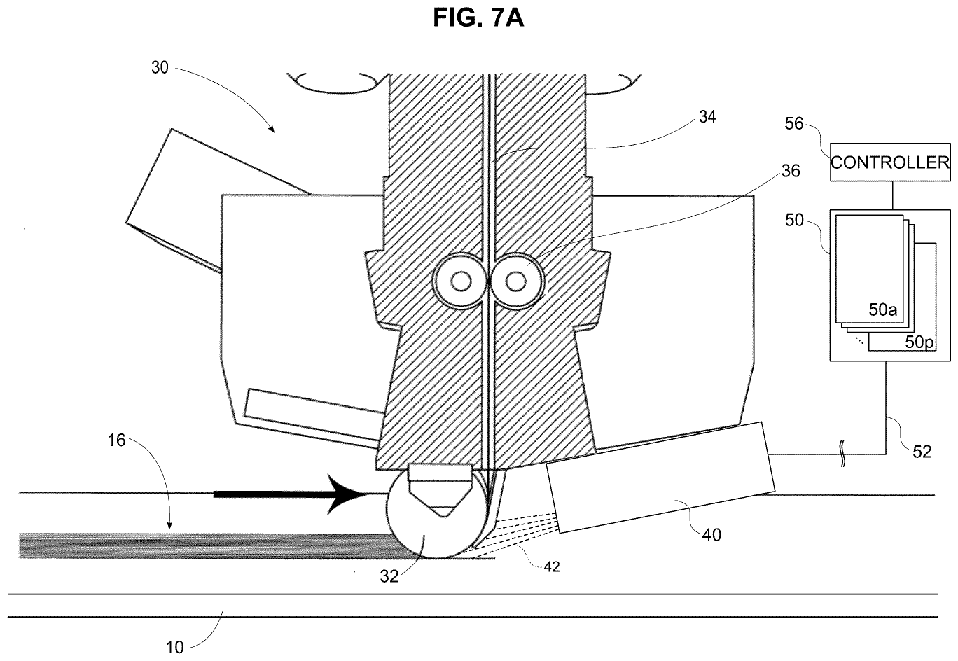

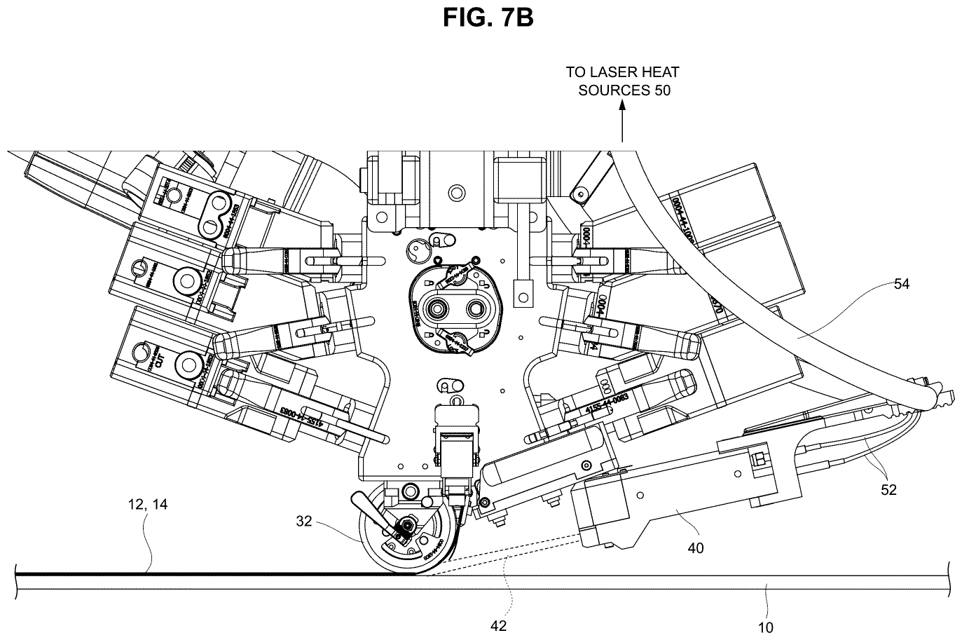

FIGS. 5 and 6 illustrate a portion of an Automated Fiber Placement (AFP) machine. The AFP machine may include an AFP head 20 configured to supply one or more tows under tension. The AFP head 20 may include a tow guidance system 30 that feeds each of the tows toward a compaction roller 32. The compaction roller 32 is configured to receive the tows from the AFP head 20 and to press the tows with pressure onto a substrate 10. The AFP head 20 may be configured to supply a full course of tows 12 (in FIG. 5) or a partial course 14 (in FIG. 6). According to various embodiments, a particular AFP head 20 may be alternately configured to supply a number of tow widths (e.g., 0.5-inch, 0.25 inch, etc.). The number of tows constituting a full course may depend on the tow widths. In general, an AFP head 20 can be configured to supply 1 to 32 tows. In a common example, a full course may include 16 tows. The tow guidance system 30 may include a tow path 34 and feed rollers 36 positioned and arranged to facilitate guidance and stable feed rate of tows directed therethrough, as seen in FIG. 7A.

FIGS. 7A and 7B are side views of a placement portion of the AFP head 20, according to embodiments. FIG. 7A is a block diagram illustrating a tow guidance system 30 portion of an AFP head 20. The guidance system 30 guides one or more tows 33 along a tow path 34 to a compaction roller 32. The compaction roller 32 presses the tows against a substrate 10, which may include one or more previously laid layers of tows forming a tow layup 16. The tow path 34 may include feed rollers 36 in some embodiments. A plurality of laser heat sources 50 in the form of laser heat source modules 50a-50p (in block diagram form), provide heat, e.g., in the form of infrared energy, via a plurality of fiber optic cables 52. Each of the laser heat source modules 50a-50p may include an electrical power supply. Though not illustrated, those having skill in the art will acknowledge the electric power supplies may be selected from a variety of standard power supplies for laser modules. The plurality of fiber optic cables 52 may comprise a plurality of fiber optic strands respectively configured to convey the infrared heat at a particular wavelength or range of wavelength from a laser heat source module (40a-40p). Those having skill in the art will acknowledge that the fiber optic cables 52 may comprise a fiber optic bundle 54 or be arranged separately in various embodiments. The fiber optic cables 52 are separated to respectively provide the infrared energy to a plurality of collimators 42 held in a chassis 41, where the chassis, collimators, mirrors and tramming mechanism together constitute an optical assembly 40. Each laser heat source module 50a-50p may be associated with a respective single tow, and each laser heat source module may be configured to generate infrared energy to heat the associated tow and/or a portion of the substrate associated with the respective tow. The plurality of fiber optic cables 52 each may be associated with a respective laser heat source module of the plurality of laser heat source modules and are arranged to convey the infrared energy from the respective laser heat source module.

According to an embodiment, the fiber optic cables 52 are terminated at a plurality of fiber optic terminations. The fiber optic terminations may include respective collimators 70. According to an embodiment the collimators may be include collimators tubes 70, as described in detail below. The plurality of collimators 70 may each be connected to a respective fiber optic cable of the plurality of fiber optic cables and may be configured to receive, collimate, and direct the collimated infrared energy 42 onto an associated tow at or in front of the nip point thereof.

The AFP machine may include a control unit 56 configured to control each of the laser heat source modules 50a-50p on and off individually consistent with supply of the respective associated tow. The control unit may be configured to control each laser heat source module 50a-50p so as to be powered on only when its associated tow is known to be fed from the AFP head 20 and being controlled to be powered off only when its associated tow is known not to be fed from the AFP head 20.

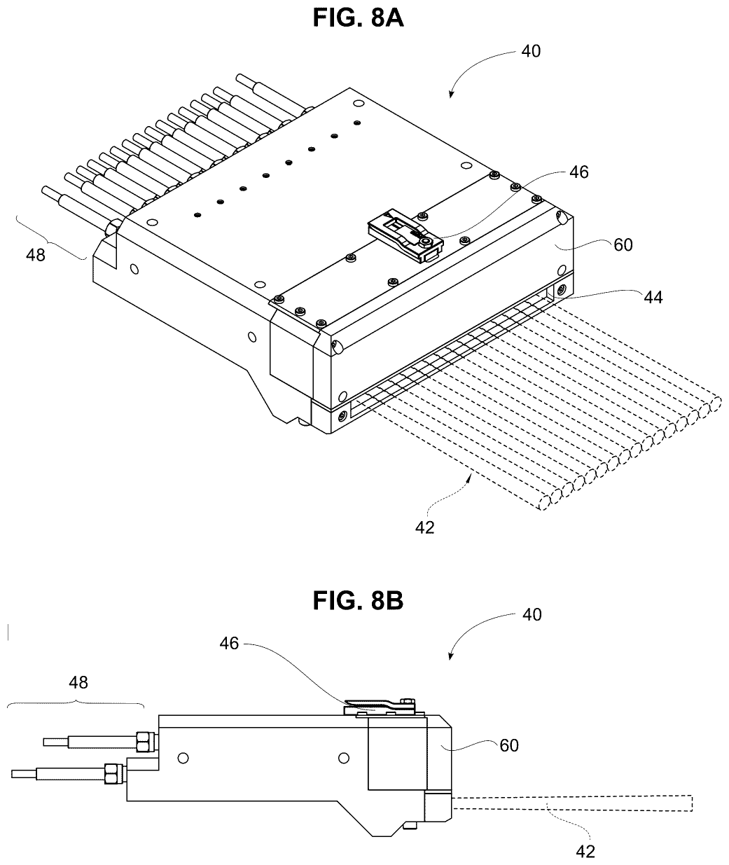

FIGS. 8A-8E show various perspectives of the optical assembly 40, according to an embodiment. In some of the views, infrared energy 42 is illustrated using dashed lines to help clarify the per-tow individual nature of the configuration. FIG. 8A is a perspective view of the optical assembly 40, according to an embodiment. The optical assembly 40 in this view is disconnected from the AFP head 20. The optical assembly 40 may include a mirror and tramming mechanism area with a cover 60. The cover 60 may be removed to access mirrors and other features as described in more detail below. A “window” 44 is provided for emission of the infrared energy 42. The optical assembly 40 may also include a thermal sensor 46 configured to monitor heat transferred to the chassis 41. Monitoring the heat can facilitate protection against overheating, help identify problems related to uncharacteristic heat, and facilitate tracking of thermal fatigue over time. The optical assembly 40 may include a plurality of fiber optic connectors 48, each associated with a respective “channel” of infrared energy. FIG. 8B is a side view of the optical assembly 40, according to an embodiment. FIG. 8C provides a front view of the optical assembly 40, according to an embodiment. In this view the infrared energy 42 has been omitted for clarity.

The chassis 41 may be configured to secure the collimators in a plurality of rows, such that collimators in each row are transversely offset with respect to collimators in an adjacent row. FIG. 8D is a top view of the optical assembly 40, according to an embodiment, in which the staggered/offset arrangement of the fiber optic connectors 48 within the chassis 41 reflects the staggered disposition of the collimator tubes 70 disposed. The transverse offset orients each row, providing a substantially uniform pitch of the collimated infrared energy directed from the respective collimators. That is, the collimators 70 and resulting collimated infrared energy 42 are substantially evenly spaced. FIG. 8E is a rear view of the chassis 41, according to an embodiment and also illustrates the offset/stagger of the rows of collimators.

Each row of collimators 70 may also be offset forward or backward (left or right in FIGS. 8B, 8D) with respect to an adjacent row of collimators.

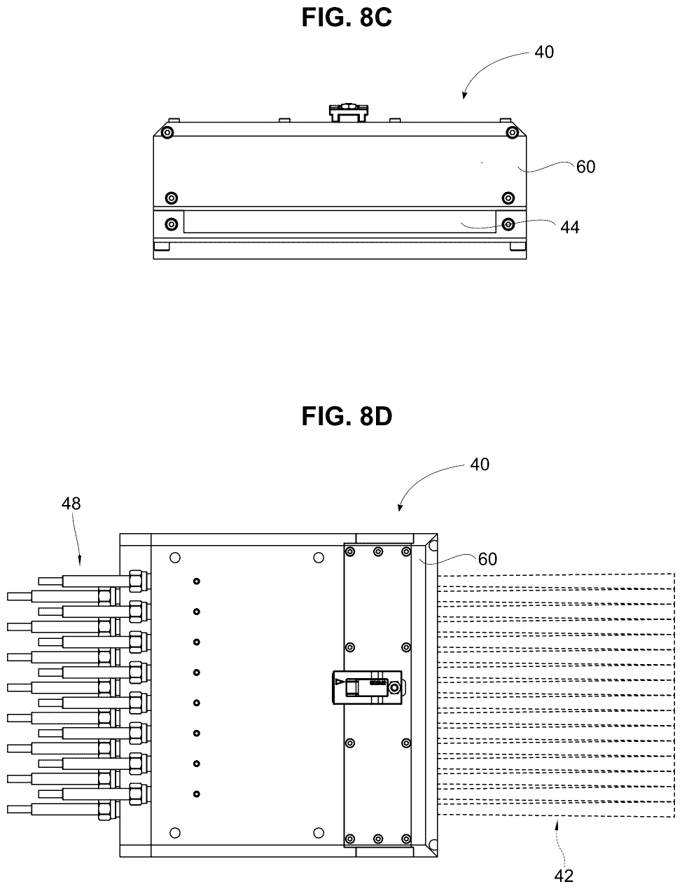

FIG. 9 is a section view of an optical assembly 40 according to an embodiment, and corresponds to the A-A section of FIG. 8E. The optical assembly 40 may include, e.g., beneath the cover 60, a plurality of first mirrors 62, second mirror 64 and a tramming mechanism 66.

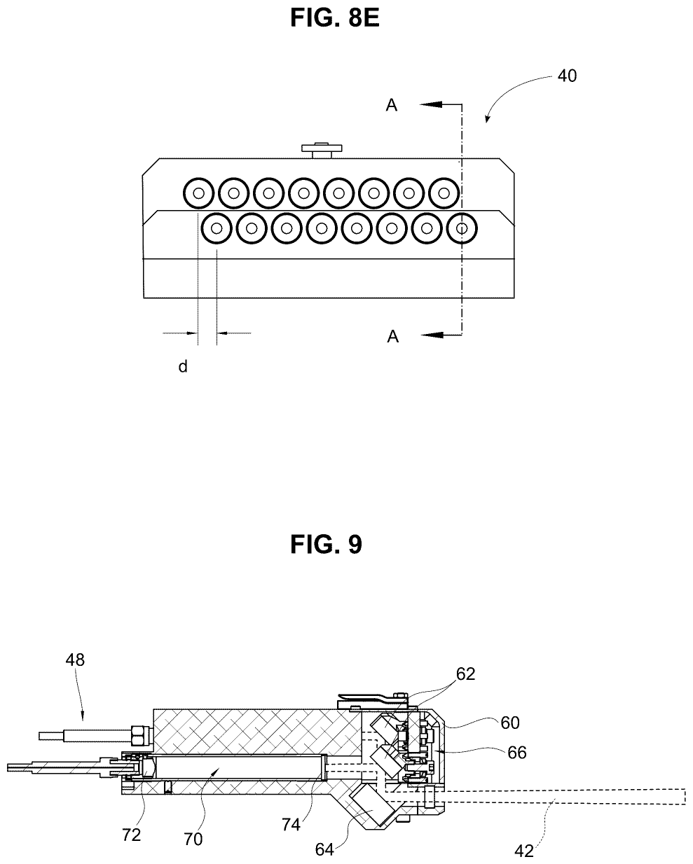

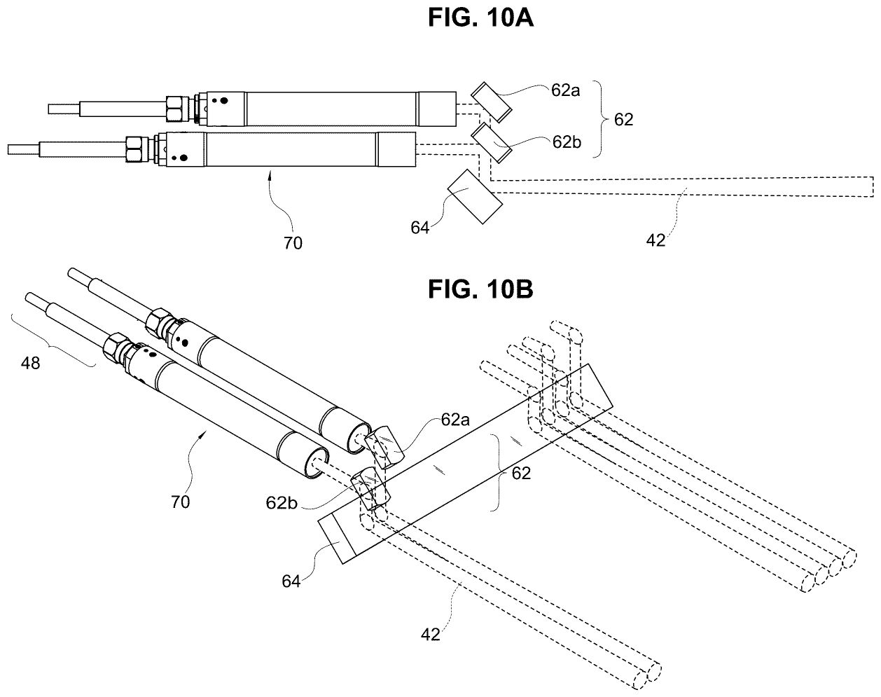

FIGS. 10A and 10B are respectively a side view and a perspective view of collimators 70 and corresponding mirrors 62, 64, according to an embodiment. A subset of the collimators 70 is shown for clarity, with one collimator 70 from each of two rows. Each first mirror 62 may be arranged to redirect the collimated infrared energy 42 from a respective collimator 70 toward a second mirror 64. The plurality of first mirrors 62 may be arranged to substantially equalize focal lengths of the infrared energy directed from each row of collimators. For example, a first row 62a of the first mirrors may be set to correspond to a first row of collimators 70 while a second row 62b of the first mirrors may be set to correspond to a second row of collimators 70. The section view in this instance illustrates a collimator 70 in a bottom row. The second mirror 64 may be oriented to direct the collimated infrared energy 42 received from the plurality of first mirrors 62 to a nip point of the respective associated tows as shown in, e.g., FIG. 7A, 7B. The second mirror 64 may be a single mirror common to each of the plurality of first mirrors 62. For example, the second mirror 64 may extend substantially across the width of the chassis 41. Nevertheless, the inventors recognize and acknowledge that the second mirror 64 could comprise individual mirrors. Without compensation, the placement of the collimators 70 on different rows would result in uneven focal lengths of the collimated infrared energy 42. For example, FIG. 11 (showing a subset of the mirrors for clarity) illustrates the distance added by the placement in different rows. As can be seen most clearly in FIG. 10A, the focal distance for each row of collimators 70 is made substantially equal by the offset of the collimators (right-left in the figure).

The optical assembly 40 may include a tramming mechanism 66 configured to adjust an orientation each first mirror 62. The tramming mechanism 66 may be configured to adjust the orientation in at least one axis. According to an embodiment, the tramming mechanism 66 can adjust the orientation of an individual first mirror on two axes to fine tune the position of a resulting laser spot on nip point.

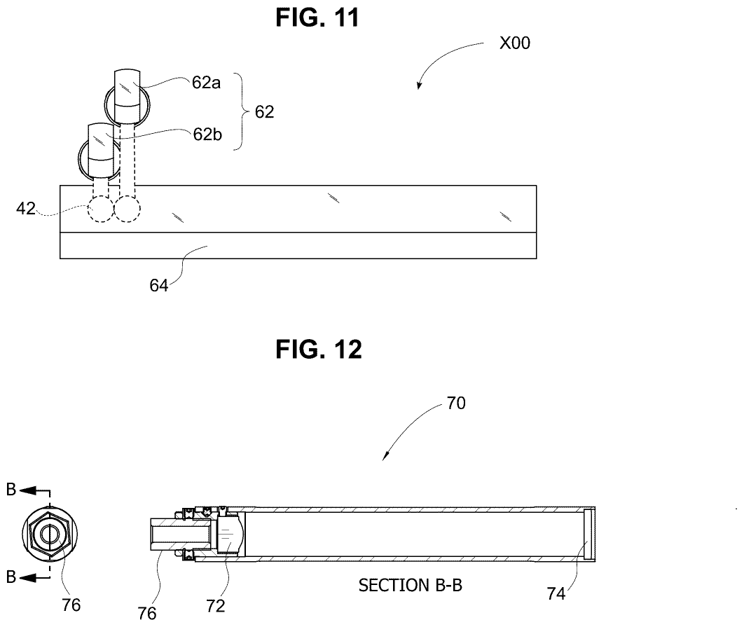

Returning to FIG. 9 and newly directing attention to FIG. 12, a collimator 70 is a device for addressing natural dispersion in an energy signal such as the infrared energy conveyed by the fiber optic cables 52. A collimator 70 may include a first lens 72 (e.g., a plano-convex lens) that receives the energy or light from a fiber optic cable 52 via a fiber optic interface 76 and converges the energy or light. A second lens 74 (e.g., another plano-convex lens) is disposed proximate an output end of the collimator 70 at a distance selected to control convergence divergence of energy directed by the first lens 72 so as to project a selected laser spot size at a predetermined focal distance from the collimator. The collimated infrared energy 42 diverges after it leaves the collimator 70, but less than it would absent the collimator.

Returning briefly to FIG. 8E, the lateral distance d between centers of the collimators 70 in aggregate may be less than 0.5 inches to correspond with the pitch of tows having a width less than 0.5 inches. The arrangement of the optical assembly 40 thus facilitates individual heating of nip points for one or more tows each having a width less than 0.5 inches. For example, when using tows having a width of 0.25 inches, the optical assembly holds the collimators 70 in two staggered rows with lateral distance between centers (i.e., distance between a vertical plane coincident with the longitudinal axis of a collimator in one row to a similar plane coincident with a nearest collimator in an adjacent row) at a 0.25-inch pitch in order to emit collimated infrared energy consistent with the 0.25-inch tows. The spacing of collimators in each row is limited by the size of the collimator tubes 70. However, those having skill in the art will acknowledge and recognize that the concepts applied herein to two rows of collimators 70 may be scaled to additional rows, for example, three or four rows, to achieve more finely pitched laser outputs.

According to an embodiment, the collimators 70 in an optical assembly 40 may disposed, in each row with 0.5-inch centers. In an implementation, collimators 70 had a diameter of approximately 11 mm (0.43 inches). Accordingly, an optical assembly 40 can be formed to hold collimators 70 in two staggered rows such that collimated infrared energy output from the optical assembly 40 has a spacing no less than 5.5 mm (0.22 inches). Consequently, for use with tows smaller than 0.25 inches (e.g., 0.125 inches), each beam of collimated energy may be applied to two tows. While this is not as efficient as the collimator-per-tow configuration for 0.25-inch tows, it is more efficient than conventional systems that heat a full course of tows, or even the applicant's systems (e.g., in parent application Ser. No. 16/783,895) that heat a tetrad of tows in order to repair one tow. The disclosed optical assembly 40 permits a reduction in a number of tows that are simultaneously heated to facilitate the repair of a single tow.

FIG. 13 is a rear view of a tow guidance system 90 of an Automated Fiber Placement (AFP) machine 20 according to an embodiment. An optical assembly 100 for an Automated Fiber Placement (AFP) machine may include a plurality of fiber optic terminations 102 configured to receive infrared energy via respective fiber optic cables 110 The fiber optic terminations 102 may be configured to collimate the infrared energy. The optical assembly 100 may include a plurality of mirrors (e.g., 62, 64 in previous figures) configured to receive the collimated infrared energy from the fiber optic terminations 102 and redirect the collimated infrared energy towards a substrate 120. The plurality of fiber optic terminations 102 may be arranged in two staggered rows. The plurality of mirrors (62, 64) may include sixteen mirrors arranged to reflect the collimated infrared energy (e.g., 42 in previous figures) onto respective nip points of respective tows being laid on the substrate. According to an embodiment, the plurality of mirrors (e.g., 62) may include at least two levels of mirrors (e.g., 62a, 62b), each level comprising eight mirrors. The plurality of mirrors (62, 64) may include a plurality of small mirrors (62) and a long mirror (64), the small mirrors (62) adjustably configured to direct the infrared energy from respective fiber optic terminations 102 toward the long mirror (64). The long mirror (64) may be configured to receive infrared energy (42) from the plurality of small mirrors (62) and reflect the collimated infrared energy (42) towards the substrate 120. The optical assembly 100 may include a tramming mechanism (66) configured to adjust the orientation of at least a subset of the mirrors in the plurality of mirrors (62, 64).

The mirrors 62, 64 in all disclosed embodiments may be formed from fused silica with specialized coatings to provide high reflectivity in the infrared wavelengths. Those having skill in the art will recognize that other materials can be applicable, depending on temperature and durability constraints.

Each fiber optic termination 102 may be configured to accommodate infrared energy received from a respective infrared energy source of a plurality of infrared energy sources, such as laser diode modules. FIG. 7A illustrates energy sources (e.g., laser drivers) in block format. In practice, the fiber optic bundle 54 efficiently carries the laser heat/energy such that the infrared energy sources 50 may be disposed remote from the fiber optic terminations at the optical assembly 40. However, in some applications it may be practical to locate the energy sources proximate to the point of use. The fiber optic terminations 70 may include collimator tubes.

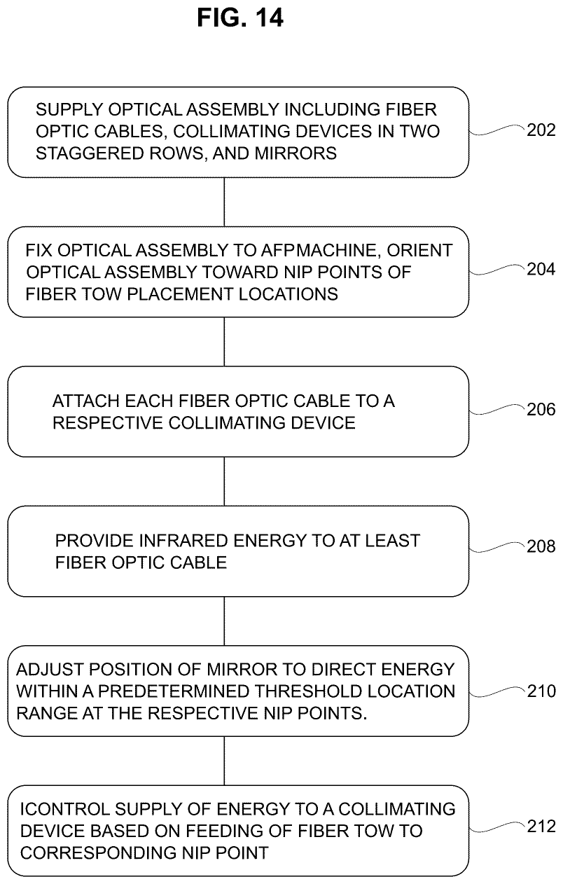

FIG. 14 illustrates operations in a method 200 for using an optical assembly, according to an embodiment. A method 200 of using an optical assembly (e.g., 40) in an Automated Fiber Placement (AFP) machine may include an operation 202 of supplying the optical assembly, the optical assembly including a plurality of fiber optic cables, a respective plurality of collimating devices arranged in at least two staggered rows, and a plurality of mirrors respectively arranged to direct infrared energy received from the collimating devices. The method 200 may further include an operation 204 of fixing the optical assembly to the AFP machine and orienting the optical assembly to emit the infrared energy toward nip points of a plurality of fiber tow placement locations. The method 200 may further include an operation 206 of attaching each of the fiber optic cables to a respective collimating device. The method 200 may further include an operation 208 of providing infrared energy to at least one of the fiber optic cables. The method 200 may further include an operation 210 of, at least once (e.g., during initial installation or setup), adjusting a position of at least a subset of the mirrors to direct infrared energy received from corresponding collimating devices within a predetermined threshold location range at the respective nip points. The method 200 may further include an operation 212 of independently controlling, with an automated controller, a supply of the infrared energy provided to at least one of the plurality of collimating devices based on whether or not the AFP machine is feeding a corresponding fiber tow to the corresponding nip point.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

What is claimed is:

1. An Automated Fiber Placement (AFP) machine, comprising:
an AFP head configured to supply one or more tows under tension;
a compaction roller configured to receive the tows from the AFP head and to press the tows with pressure onto a substrate;
a plurality of laser heat sources, in the form of laser heat source modules each with an electrical power supply, each laser heat source module associated with a respective single tow, each laser heat source module configured to generate infrared energy to heat the associated tow and/or a portion of the substrate associated with the associated tow;
a plurality of fiber optic cables each associated with a respective laser heat source module of the plurality of laser heat source modules and arranged to convey the infrared energy from the respective laser heat source module;
a plurality of collimators each connected to a respective fiber optic cable of the plurality of fiber optic cables and configured to receive, collimate, and direct the infrared energy onto the associated tow at or in front of the nip point thereof; and
a control unit configured to control each of the laser heat source modules on and off individually consistent with the supply of its respective associated tow, the control unit controlling each laser heat source module so as to be powered on only when its associated tow is known to be fed from the AFP head and being controlled to be powered off only when its associated tow is known not to be fed from the AFP head.

2. The AFP machine according to claim 1, further comprising a collimator block configured to secure the collimators in a plurality of rows, collimators in each row being transversely offset with respect to collimators in an adjacent row, the transvers offset orienting each row providing a substantially uniform pitch of the collimated infrared energy directed from the respective collimators;
a plurality of first mirrors, each first mirror arranged to redirect the collimated infrared energy from a respective collimator toward a second mirror; and
the second mirror oriented to direct the collimated infrared energy received from the plurality of first mirrors to the nip point of the respective associated tows.

3. The AFP machine according to claim 2, wherein the second mirror is common to each of the plurality of first mirrors.

4. The AFP machine according to claim 2, further comprising a tramming mechanism configured to adjust an orientation each first mirror.

5. The AFP machine according to claim 4, wherein the tramming mechanism is configured to adjust the orientation in at least one axis.

6. The AFP machine according to claim 2, wherein each row of collimators is offset forward or backward with respect to an adjacent row of collimators, and the plurality of first mirrors are arranged to substantially equalize focal lengths of the infrared energy directed from each row of collimators.

7. The AFP machine according to claim 1, wherein the one or more tows each have a width of less than 0.5 inches, and
the plurality of collimators is arranged such that respective vertical planes passing through the longitudinal axis of each collimator are less than 0.5 inches apart.

8. An optical assembly for an Automated Fiber Placement (AFP) machine, comprising:
a plurality of fiber optic terminations configured to receive infrared energy, and to collimate the infrared energy; and
a plurality of mirrors configured to receive the collimated infrared energy from the fiber optic terminations and redirect the collimated infrared energy towards a substrate.

9. The system of claim 8, wherein the plurality of fiber optic terminations are arranged in two staggered rows.

10. The optical assembly of claim 8, wherein the plurality of mirrors comprises sixteen mirrors arranged to reflect the collimated infrared energy onto respective nip points of respective tows being laid on the substrate.

11. The optical assembly of claim 10, wherein the plurality of mirrors comprises at least two levels of mirrors, each level comprising eight mirrors.

12. The optical assembly of claim 8, further comprising a chassis configured to stably support the fiber optic terminations and the mirrors.

13. The optical assembly of claim 8, wherein the plurality of mirrors includes a plurality of small mirrors and a long mirror, the small mirrors adjustably configured to direct the infrared energy from respective fiber optic terminations of the plurality of fiber optic terminations toward the long mirror, the long mirror configured to receive infrared energy from the plurality of small mirrors and reflect the collimated infrared energy towards the substrate.

14. The optical assembly of claim 8, further comprising a tramming mechanism configured to adjust the orientation of at least a subset of the mirrors in the plurality of mirrors.

15. The optical assembly of claim 8, wherein the mirrors are formed from fused silica with specialized coatings to provide high reflectivity in the infrared wavelengths.

16. The optical assembly of claim 8, wherein each fiber optic termination is configured to accommodate infrared energy received from a respective infrared energy source of a plurality of infrared energy sources.

17. The optical assembly of claim 16, wherein the plurality of infrared energy sources includes laser diode modules.

18. The optical assembly of claim 16, wherein the plurality of infrared energy sources are disposed distal from the AFP head.

19. The optical assembly of claim 18, wherein the fiber optic cables traverse a distance between the plurality of infrared energy sources and the fiber optic terminations as a bundle of fibers configured to accommodate movements of the optical assembly.

20. The optical assembly of claim 8, wherein the fiber optic terminations and mirrors are configured to provide equal heat distribution to each of a plurality of fiber tows being laid onto the substrate.

21. The optical assembly of claim 8, w herein the fiber optic terminations are collimator tubes.

22. A method of using an optical assembly in an Automated Fiber Placement (AFP) machine, the method comprising:
supplying the optical assembly, the optical assembly including a chassis, a plurality of fiber optic cables, a respective plurality of collimating devices arranged in at least two staggered rows, and a plurality of mirrors respectively arranged to direct infrared energy received from the collimating devices;
fixing the optical assembly to the AFP machine and orienting the optical assembly to emit the infrared energy toward nip points of a plurality of fiber tow placement locations;
attaching each of the fiber optic cables to a respective collimating device held within the chassis;
providing infrared energy to at least one of the fiber optic cables;
at least once, adjusting a position of at least a subset of the mirrors to direct infrared energy received from corresponding collimating devices within a predetermined threshold location range at the respective nip points; and
independently controlling, with an automated controller, a supply of the infrared energy provided to at least one of the plurality of collimating devices based on whether or not the AFP machine is feeding a corresponding fiber tow to the corresponding nip point.
